(19) United States
(12) Patent Application Publication
(10) Pub. No.: US 2023/0182498 A1
(43) Pub. Date: Jun. 15, 2023

(54) MULTIDIRECTIONAL PAPER CLIP

(71) Applicant: Christopher Joseph Walshe, Suffolk, VA (US)

(72) Inventor: Christopher Joseph Walshe, Suffolk, VA (US)

(21) Appl. No.: 18/059,514

(22) Filed: Nov. 29, 2022

Related U.S. Application Data
(60) Provisional application No. 63/360,373, filed on Sep. 29, 2021.

(51) Int. Cl. B42F 1/02

(52) U.S. Cl. CPC B42F 1/02

(57) ABSTRACT

A multidirectional paper clip formed from an endless length of a flexible strand forming two elongated frames and, wherein each elongated frame and has a pair of opposing side rails. The first pair of opposing rails may define a first plane, and wherein a second pair of opposing rails may have an outermost rail occupying a second plane while the innermost rail extends downwardly from an upper end portion to a lower end portion occupying a third plane on the opposite side of the first plane relative to its upper end portion.

### CROSS-REFERENCE TO RELATED APPLICATION

This application claims the benefit of priority of U.S. provisional application No. 63/360,373, filed Sep. 29, 2021 the contents of which are herein incorporated by reference.

### BACKGROUND OF THE INVENTION

The present invention relates to improved paper clips and, more particularly, a multidirectional paper clip.

Current paper clips, when binding material, must be applied to and released from the would-bound material in only one direction due to the blunt ends of the clip construction.

As can be seen, there is a need for a multidirectional paper clip that can define a binding engagement with the material to be found from multiple directions.

### SUMMARY OF THE INVENTION

In one aspect of the present invention, a clip constructed of an endless length of wire of any flexible materials such as or for one example plastic forming first and second elongated frames, each elongated frame having a pair of opposing rails (and terminal loops), wherein the first pair of opposing rails (and curved terminal loops) occupies a first plane, and wherein the second pair of opposing rails (and terminal curved loops) includes an outermost rail occupying a second plane; and an innermost rail disposed inwardly within the first elongated frame, wherein the innermost rail extends downwardly from the second plane through the first plane and then terminating at a third plane, wherein two gaps are formed between the first and second pair opposing rails on both end portions of the innermost rail, and wherein the two gaps are on opposing sides of the first pair of opposing rails, said end portions being so arranged as to cause a stack of paper inserted between said end portion and the first pair of opposing rails to be urged substantially equally against both of said first pair of opposing rails, wherein each end portion of the second pair of opposing rails is disposed on different sides of the first pair of opposing rail.

In another aspect of the present invention, a clip constructed of an endless length of wire forming first and second elongated frames, each elongated frame having a pair of opposing rails (and curved loops), wherein the first pair of opposing rails occupies a first plane, and wherein the second pair of opposing rails has two end portions, each end out of plane with the first plane and each other, said end portions being so arranged as to cause a stack of paper inserted between said end portions and the first pair of opposing rails (and curved loops) to be urged substantially equally against both of said first pair of opposing rails (and curved loops), wherein the out of plane relationship between the first and second rails defines a gap for receiving said stack (of paper or other planar sheet like material).

In another aspect of the present invention, a method of binding a plurality of sheet portions together, the method including providing the above-mentioned clip; binding said plurality of sheet portions together by urging them between a first end portion of the two end portions and the opposing rails of the first pair of elongated frames; removing said plurality of sheet portions from between the first end portion of the two end portions; and binding said plurality of sheet portions together by urging them between a second end portion of the two end portions and the opposing rails of the first pair of elongated frames, whereby said plurality of sheet portions can be selectively bound by either of the two end portions.

These and other features, aspects and advantages of the present invention will become better understood with reference to the following drawings, description, and claims.

### BRIEF DESCRIPTION OF THE DRAWINGS

FIG. 1 is a top front perspective view of an exemplary embodiment of the present invention.

FIG. 2 is a top rear perspective view of an exemplary embodiment of the present invention.

FIG. 3 is a front elevation view of an exemplary embodiment of the present invention.

FIG. 4 is a side elevation view of an exemplary embodiment of the present invention.

FIG. 5 is a section view of an exemplary embodiment of the present invention, taken along line 5-5 in FIG. 3.

FIG. 6 is a perspective view of an exemplary embodiment of the present invention, illustrating the binding of material 26 via the first gap/binding point 22.

FIG. 7 is a perspective view of an exemplary embodiment of the present invention, illustrating rotation of the multidimensional paper clip between the two opposing binding points 22 and 24.

FIG. 8 is a perspective view of an exemplary embodiment of the present invention, illustrating the binding of material 26 via the second gap/binding point 24.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a multidirectional applicating/application paper clip.

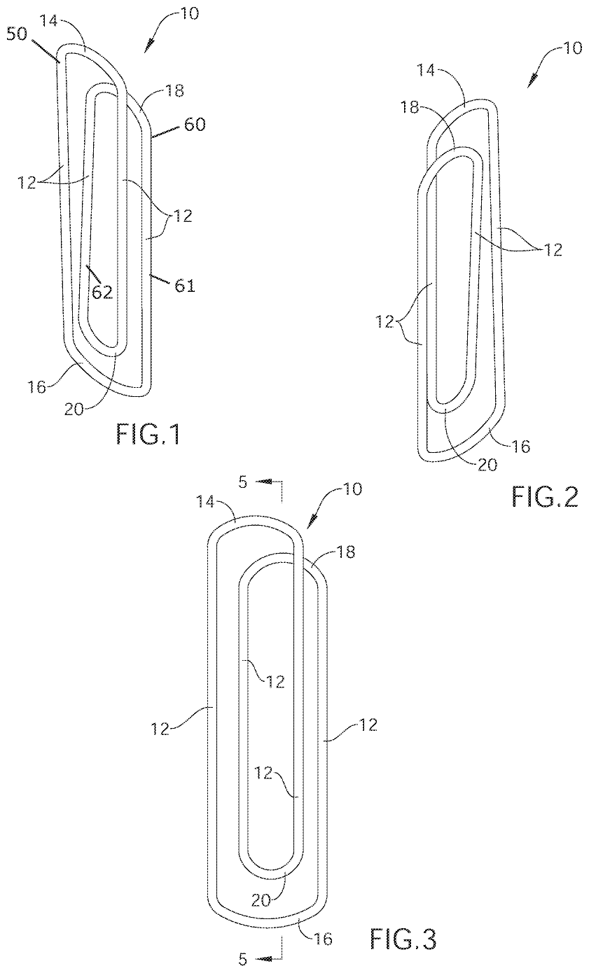

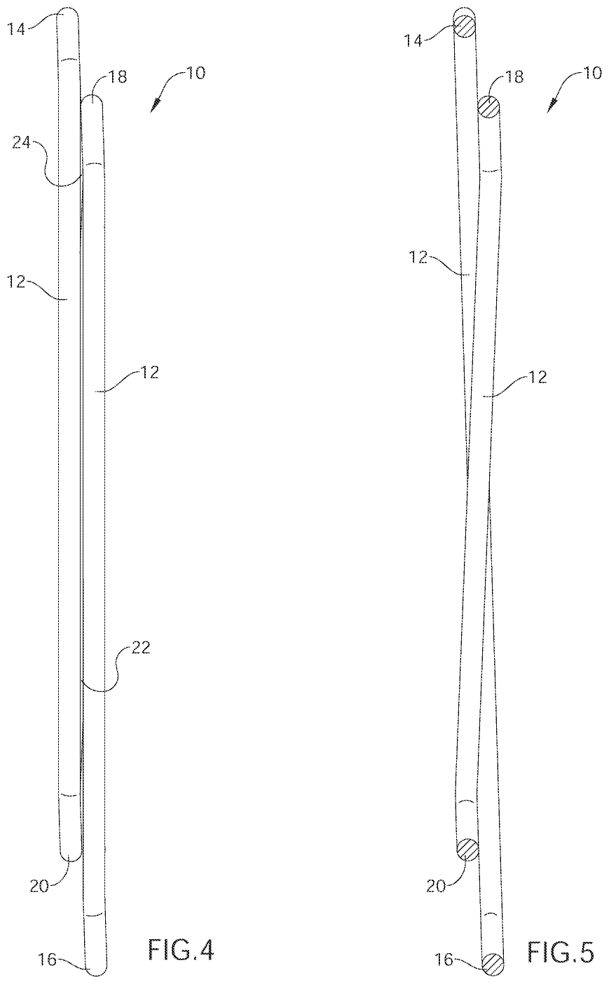

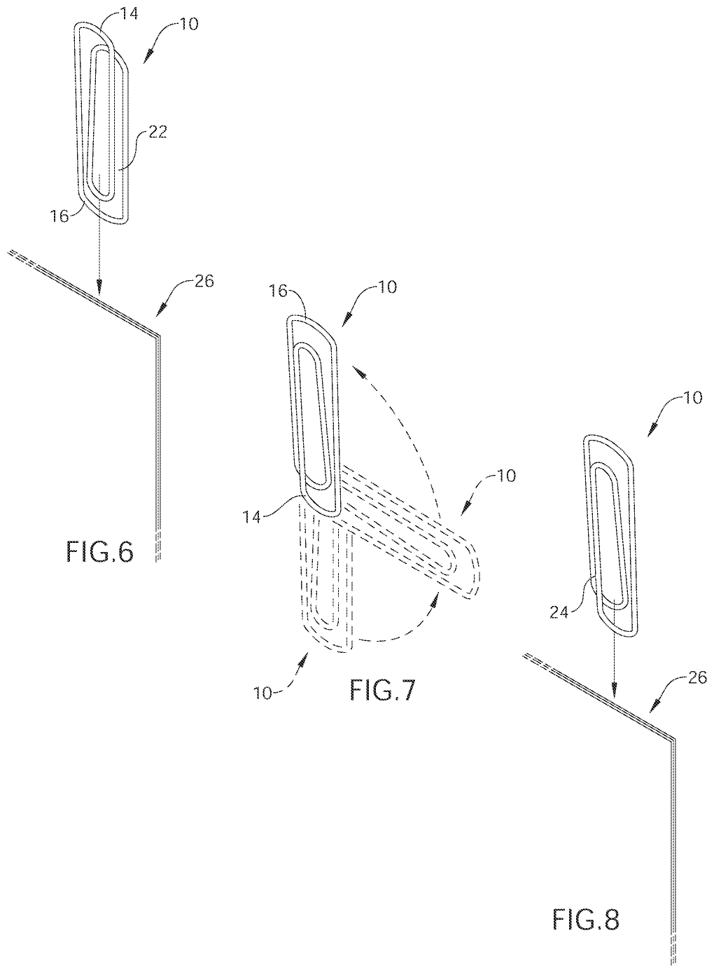

Referring now to FIGS. 1 through 8, the present invention may include a multidirectional paper clip 10 formed from an endless length of a wire forming two elongated frames 50 and 60, wherein each elongated frame 50 and 60 has a pair of opposing side rails 12. The first pair of opposing rails 12 may define a first plane, and wherein a second pair of opposing rails may have an outermost rail 62 occupying a second plane while the innermost rail extends downwardly from an upper end portion 18 to a lower end portion 20 occupying a third plane on the opposite side of the first plane relative to its upper end portion 18, as illustrated in FIG. 5. It should be noted the end portions, such as 14, 16, 18, and 20 are shown curved, but it is also within the scope of the present invention that these end portions may be squared off or rectangular, lobulated, triangular and may contain a logo, design, trademark, receptacle, =be made of plastic, metal, or glass, and be various geometric shapes.

The diagonal orientation of the innermost rail 62 allows it to extend from opposing sides of the plane defined by the bigger first elongate frame 50. The lower end portion 20 (or inner loop) is disposed the opposing rails 12 of the first pair. The lower end portion 20 (or inner loop) is disposed upward of the lower end portion 16 of the first elongated frame 50. The upper end portion 18 of the second elongated frame 60 is downward of the upper end portion 14 of the first elongated frame 50.

This bidirectional out of plane configuration forms a first gap/binding point 22 (between opposing end points 16 and 20) and a second gap/binding point 24 (between opposing points 14 and 18) for receiving material to be bound. The binding points 22 and 24 are formed between both end portions 18 and 20, respectively, of the second elongated frame 60 and the opposing rails of the first elongated frame 50. The binding points 22 and 24 may be defined by a visible, a non-zero dimension, gap between the relative end portion 18 or 20 and the opposing rails 12 of the first elongated frame 50. In certain embodiments, there may be no gap and so a user would need to urge the material 26 into the bind point, possibly by flexing different portions of the first and/or second elongated frames 50 and 60.

The bent or formed wire provides spring-like tension whereby the end portions of the second elongated frame 60 cause a stack of paper or other material 26 inserted between said end portion and the first pair of opposing rails 12 to be urged substantially equally against both of said first pair of opposing rails 12. It should be noted that the wire may be any flexible strand of material that facilitates the functionality disclosed herein, wherein the material may include but not limited to metallic, plasticized materials, etc.

The multidirectional paper clip 10 may be utilized to secure reversibly two or more pieces of planar material for example paper or plastic sheets. However, the composition or combination of the sheets may be composed of other materials. The multidirectional paper clip 10 is applied over the sheets to be combined with one arm of the clip on each side of the combined documents or sheets reversibly secured between the two arms of the device utilizing the distal application loop points and progression of the sheets to be secured between the inner lateral longitudinal and the outer longitudinal application points. The planar surfaces or components are therefore reversibly secured together. The sheets of material to be combined are usually combined flat planar surface to flat planar surface but can be applied or secured can be secured end to end.

In summary the paper clip can be slid over the pages and or sheets to be combined in multiple directions and then slid or pulled off the sheets in the opposite or reverse direction resulting in individual or uncombined sheets of material. The applied sheets can be secured face to face or side by side utilizing individual or multiple clips 10.

The multidirectional paper clip 10 could be made utilizing three-dimensional manufacture using materials such as metal, plastic or other material which is flexible and can therefore apply tension may be utilized. The multidirectional paper clip 10 can be applied over sheets of paper to be reversibly combined in more than one direction.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the invention as set forth in the following claims.

What is claimed is:

1. A clip constructed of an endless length of wire forming first and second elongated frames, each elongated frame having a pair of opposing rails, wherein the first pair of opposing rails occupies a first plane, and wherein the second pair of opposing rails comprises:
an outermost rail occupying a second plane; and
an innermost rail disposed inwardly within the first elongated frame, wherein the innermost rail extends downwardly from the second plane through the first plane and then terminating at a third plane.

2. The clip of claim 1, wherein two gaps are formed between the first and second pair opposing rails on both end portions of the innermost rail, and wherein the two gaps are on opposing sides of the first pair of opposing rails, said end portions being so arranged as to cause a stack of material inserted between said end portion and the first pair of opposing rails to be urged substantially equally against both of said first pair of opposing rails.

3. The clip of claim 1, wherein each end portion of the second pair of opposing rails is disposed on different sides of the first pair of opposing rail.

4. A clip constructed of an endless length of wire forming first and second elongated frames, each elongated frame having a pair of opposing rails, wherein the first pair of opposing rails occupies a first plane, and wherein the second pair of opposing rails has two end portions, each end portion out of plane with the first plane and each other, said end portions being so arranged as to cause a stack of material inserted between said end portions and the first pair of opposing rails to be urged substantially equally against both of said first pair of opposing rails.

5. The clip of claim 4, wherein the out of plane relationship between the first and second rails defines a gap for receiving said stack.

6. A method of binding a plurality of sheet portions together, the method comprising:
providing the clip of claim 5;
binding said plurality of sheet portions together by urging them between a first end portion of the two end portions and the opposing rails of the first pair of elongated frames;
removing said plurality of sheet portions from between the first end portion of the two end portions; and
binding said plurality of sheet portions together by urging them between a second end portion of the two end portions and the opposing rails of the first pair of elongated frames,
whereby said plurality of sheet portions can be selectively bound by either of the two end portions.
